(19) United States
(12) Patent Application Publication
(10) Pub. No.: US 2019/0051170 A1
(43) Pub. Date: Feb. 14, 2019

(54) NON-OBTRUSIVE ONCOMING EMERGENCY VEHICLE PREWARNING SYSTEM

(71) Applicant: Gregory Richard Wood, Prince George (CA)

(72) Inventor: Gregory Richard Wood, Prince George (CA)

(21) Appl. No.: 15/675,299

(22) Filed: Aug. 11, 2017

(51) Int. Cl. G08G 1/0965; G08G 1/0967

(52) U.S. Cl. CPC G08G 1/0965; G08G 1/096725

(57) ABSTRACT

A non-obtrusive oncoming emergency vehicle prewarning system includes a transmitting unit installed in an emergency vehicle that transmits a one-way signal, a plurality of receiving units mounted on a dashboard of civilian vehicles that receives the signal transmitted from the emergency vehicle, and a compact visual and audio display unit that informs a motorist of the civilian vehicles of the relative position of the emergency vehicle such that the motorist has advance warning of the emergency vehicle that is oncoming and is able to move to a side of the road allowing the emergency vehicle to safely pass.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of vehicular safety devices and more specifically relates to an emergency vehicle warning system.

### 2. Description of Related Art

Accidents sometimes happen when a driver of a vehicle is suddenly confronted with a quickly approaching traveling ambulance, police carl, or other emergency vehicle with a cacophony of blinding lights and blaring sirens and the associated confusion of the other civilian drivers.

Usually emergency vehicles are limited to activating their lights and sirens in order to get the attention of vehicle drivers they need to pass to get to a final destination. The lights typically will get a motorist's attention, but sometimes motorists are distracted or lost in thought or their own little world and fail to see the lights in the rear-view mirror. Occasionally, the siren will get the attention of distracted drivers; however, it is not uncommon today for drivers to be playing loud music on the radio or be on the cell phone and not hear the sirens from the emergency vehicle. It would be a benefit for everyone concerned to have an emergency vehicle alert system that solved the aforementioned problems, and that is unobtrusive for motorists.

U.S. Pat. No. 6,252,521 to Willie J. Griffin relates to an emergency vehicle alert system. The described emergency vehicle alert system includes transmitter units mountable within emergency vehicles and receiver units mountable within civilian vehicles. The transmitter units and the receiver units via a mechanism within each receiver unit that provides each civilian driver with an indicator of the distance between his/her civilian vehicle and the emergency vehicle.

### BRIEF SUMMARY OF THE INVENTION

In view of the foregoing disadvantages inherent in the known vehicular safety device art, the present disclosure provides a novel non-obtrusive emergency vehicle prewarning system. The general purpose of the present disclosure, which will be described subsequently in greater detail, is to provide a non-obtrusive emergency vehicle prewarning system comprising a transmitting unit installed in an emergency vehicle that transmits a signal, and a non-obtrusive receiving unit mounted on the dashboard of a civilian vehicle that receives the signal transmitted from the emergency vehicle. The non-obtrusive receiving unit may comprise a compact visual and audio display that is configured to inform a motorist of the civilian vehicle of the relative position of the emergency vehicle such that the motorist has warning that the emergency vehicle is oncoming to safely move to a side of the road promoting safer driving conditions.

A non-obtrusive oncoming emergency vehicle prewarning system is disclosed herein. The non-obtrusive oncoming emergency vehicle prewarning system may include an emergency signal-transmitting device configured to be installed to at least one emergency vehicle. The emergency signal alert device may comprise a device-housing, the device-housing internally including a signal-transmitting-processor, a signal-transmitter, and at least one power source configured to provide operating power to the emergency signal alert device. The signal-transmitting-processor is in communication with the signal-transmitter and a signal-activator located on a face of the device-housing.

The non-obtrusive oncoming emergency vehicle prewarning system may further comprise at least one emergency signal receiving unit configured to be installed to at least one civilian vehicle. The emergency signal receiving unit may comprise a receiving-processor in communication with a signal-receiver and at least one emergency signal indicator. In addition, the emergency signal receiving unit may comprise a display screen in communication with the receiving-processor and the signal-receiver. The emergency signal receiving unit may further comprise an emergency signal receiving power source for providing operating power to the emergency signal receiving unit.

During use, the signal-transmitter of the emergency signal transmitting device may be configured to wirelessly transmit at least one emergency signal to the signal-receiver of the emergency signal receiving unit when activated by a user via the signal-activator. The at least one emergency signal indicator comprises a beacon configured to alert a motorist of the at least one civilian vehicle that the at least one emergency vehicle may be in a zone of proximity to the at least one civilian vehicle.

The display screen may be programmed to display a plurality of directional arrows. The plurality of directional arrows may be programmed to indicate a direction of the at least one emergency vehicle relative to the civilian vehicle such that the motorist has sufficient reaction time to allow the at least one emergency vehicle to safely pass and to prevent an accident.

A method of using the non-obtrusive oncoming emergency vehicle prewarning system is also disclosed herein. The method of using the non-obtrusive oncoming emergency vehicle prewarning system may comprise the steps of: providing an emergency signal transmitting device for use by at least one emergency vehicle and an emergency signal receiving unit for use by at least one civilian vehicle; mounting the emergency signal transmitting device inside the at least one emergency vehicle; mounting the emergency signal receiving unit inside the at least one civilian vehicle; activating the emergency signal transmitting device when the at least one emergency vehicle may be in motion transmitting at least one emergency signal via a signal-transmitter of the emergency signal transmitting device; receiving the at least one emergency signal via a signal-receiver of the emergency signal receiving unit; warning a motorist of the at least one civilian vehicle of a proximity of the at least one emergency vehicle; and moving the at least one civilian vehicle to a side of a road enabling the at least one emergency vehicle to safely pass.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, non-obtrusive emergency vehicle prewarning system, constructed and operative according to the teachings of the present disclosure.

FIG. 1 is a perspective view of the non-obtrusive oncoming emergency vehicle prewarning system during an ‘in-use’ condition showing an emergency signal-transmitting device installed to a dashboard of an emergency vehicle (such as a police squad car), according to an embodiment of the disclosure.

FIG. 2 is a perspective view of the non-obtrusive oncoming emergency vehicle prewarning system of FIG. 1 during another ‘in-use’ condition showing an emergency signal receiving unit installed to a dashboard of a civilian vehicle according to an embodiment of the present disclosure.

FIG. 3 is a perspective view of the non-obtrusive oncoming emergency vehicle prewarning system comprising a kit including the emergency signal-transmitting device, the emergency signal receiving unit, and a set of user instructions according to an embodiment of the present disclosure.

FIG. 4 is a birds-eye view of the non-obtrusive oncoming emergency vehicle prewarning system of FIGS. 1-3 showing an emergency signal transmitted from the emergency signal-transmitting device to the emergency signal receiving units within range thereby indicating to motorists that the emergency vehicle is oncoming and to move aside, according to an embodiment of the present disclosure.

FIG. 5 is a flow diagram illustrating a method of use for the non-obtrusive oncoming emergency vehicle prewarning system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to vehicular safety devices and more particularly to a non-obtrusive emergency vehicle prewarning system as used to improve roadway safety when an emergency vehicle is in route on an emergency call.

Generally, the non-obtrusive emergency vehicle prewarning system may comprise a one-way communication system that is configured to warn civilian vehicles of approaching emergency vehicles, and the direction the emergency vehicle is coming from. The non-obtrusive emergency vehicle prewarning system is essentially a two-part system comprising a transmitting device installed in emergency vehicles configured to transmit a signal having an approximate range of about 300 meters. A receiving unit may be installed within civilian vehicles configured to receive the signal within the 300-meter range. The receiving unit is structured and arranged in a non-obstructive manner, and preferably comprises a plurality of indicator options (such as a screen display, a blinking light, and audio cues) to alert the motorist when an emergency vehicle is within range.

In one embodiment, the display of the receiving unit may comprise a plurality of directional arrows (forward, rear, left, and right) indicating to the motorist the direction the emergency vehicle is traveling from, thereby giving the motorist time to react accordingly. Once the emergency vehicle has passed, or has changed direction, the receiver may return to a standby mode.

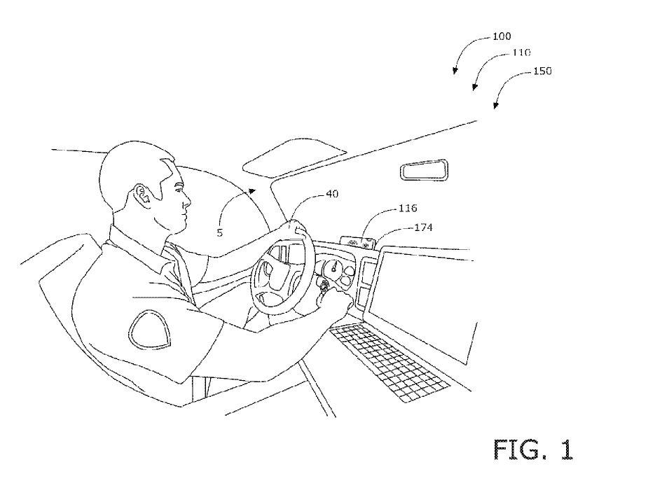

Referring now more specifically to the drawings by numerals of reference, there is shown in FIGS. 1-5, various views of a non-obtrusive emergency vehicle prewarning system 100.

Referring now to FIG. 1 showing a perspective view of the non-obtrusive oncoming emergency vehicle prewarning system 100 during an ‘in-use’ condition 150 showing an emergency signal-transmitting device 110 installed to a dashboard 8 of an emergency vehicle 5 (such as a police squad car). As shown, the emergency signal-transmitting device 110 may be configured to be installable to an at least one emergency vehicle 5, the emergency signal alert device comprising a device-housing 112, the device-housing internally including a signal-transmitting-processor 114, a signal-transmitter 116, and at least one power source 118 configured to provide operating power to the emergency signal alert device 110.

In continuing to refer to FIG. 1, the signal-transmitting-processor 114 may be in communication with the signal-transmitter 116 and a signal-activator 115, the emergency signal transmitting power source 118. The signal-activator 115 may comprise a switch or a button, and is preferably, the signal-activator 115 is located on a face of the device-housing 112 such that it may be readily accessible to the user 40. When the signal-activator 115 is activated, the signal-transmitting-processor 114 may cause the signal-transmitter 116 to transmit an emergency signal 135.

In one embodiment of the present invention, the device-housing 112 of the emergency signal-transmitting device may be mounted to the dashboard 8 of the emergency vehicle 5 via a dashboard mount 174. The dashboard mount 174 may comprise at least one adhesive. In other embodiments, the dashboard mount 174 may comprise a hook and loop fastener, dual mating magnets, clips and fasteners, or a built-in dashboard mount.

It should be noted that emergency vehicle 5 may include police and squad cars, ambulances, fire engines, and other fire, police, and medical emergency vehicles. Emergency vehicles 5 may further include government vehicles, army vehicles, and national guard vehicles.

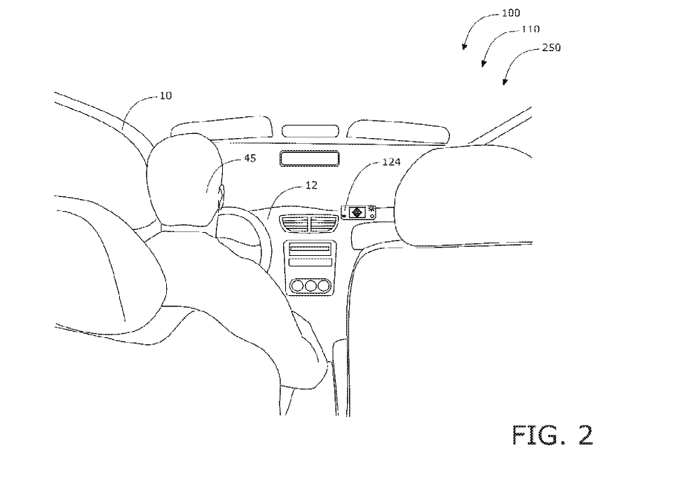

Referring now to FIG. 2 showing a perspective view of the non-obtrusive oncoming emergency vehicle prewarning system 100 during another ‘in-use’ condition 250 showing an emergency signal receiving unit 120 installed to a dashboard 12 of a civilian vehicle 10 according to an embodiment of the present disclosure. As shown, the emergency signal receiving unit 120 may comprise a receiving-processor 122 in communication with a signal-receiver 124 and at least one emergency signal indicator 126. The emergency signal receiving unit 120 may further comprise a display screen 130, the display screen 130 in communication with the receiving-processor 122 and the signal-receiver 124. Further, the emergency signal receiving unit 120 may further comprise an emergency signal receiving power source 128 for providing operating power to the emergency signal receiving unit 120.

In continuing to refer to FIG. 2, it should be noted that the signal-transmitter 116 of the emergency signal transmitting device 110 is configured to wirelessly transmit at least one emergency signal 135 to the signal-receiver 124 of the emergency signal receiving unit 120 when activated by the user 40 via the signal-activator 115. The signal-receiver 124 of the emergency signal receiving unit 120 is configured to receive the emergency signal 135. Upon receipt of the emergency signal 135, the receiving-processor may be configured to activate at least one emergency signal indicator 126 of the emergency signal receiving unit 120 useful for indicating to a motorist 45 of the civilian vehicle 10 that at least one emergency vehicle 5 may be oncoming. In such a manner, the at least one emergency signal indicator 126 comprises a beacon 160 useful for indicating to the motorist 45 of the civilian vehicle 10 that at least one emergency vehicle 5 is in a zone of proximity 160 to the civilian vehicle 10.

In continuing to refer to FIG. 2, at least one emergency signal indicator 126 is shown comprising a display screen 130 programmed to display a plurality of directional arrows 132. The plurality of directional arrows 132 may configured to indicate a direction of the at least one emergency vehicle 10 such that the motorist 45 has sufficient reaction time to allow the at least one emergency vehicle 10 to safely pass to prevent an accident from occurring. It should be appreciated that the plurality of directional arrows 132 may comprise an up arrow (indicating the emergency vehicle 5 is ahead of the civilian vehicle 10), a down arrow (indicating the emergency vehicle 5 is behind the civilian vehicle 10), a left arrow (indicating the emergency vehicle 5 is to the left of the civilian vehicle 10), and a right arrow (indicating the emergency vehicle 5 is to the right of the civilian vehicle 10).

In still referring to FIG. 2, it should be noted that the emergency signal receiving unit 120 is structured and arranged to be inconspicuously mounted to a dashboard of the at least one civilian vehicle 10 such as to not distract the motorist 45 while driving. In such a manner, an enclosure of the emergency signal receiving unit 120 is preferably constructed to be non-obtrusive such as not to obstruct important dials or measurement instruments within the civilian vehicle 10.

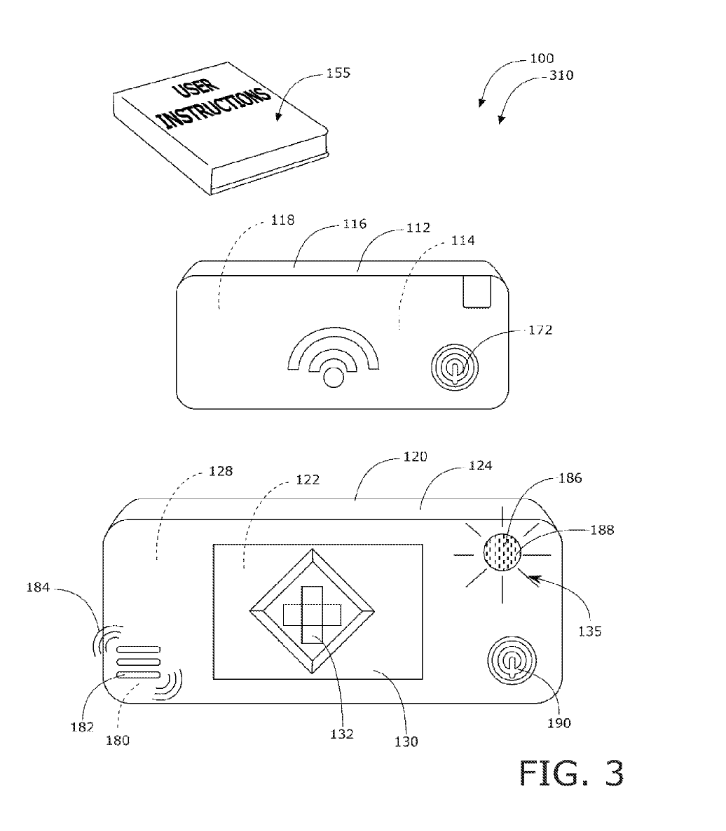

Referring now to FIG. 3 showing a perspective view of the non-obtrusive oncoming emergency vehicle prewarning system 100 comprising a kit 310 including the emergency signal-transmitting device 110, the emergency signal receiving unit 120, and a set of user instructions 155 according to an embodiment of the present disclosure of FIGS. 1 and 2. The instructions may detail functional relationships in relation to the structure of the oncoming emergency vehicle prewarning system 100 (such that the oncoming emergency vehicle prewarning system 100 can be used, maintained, or the like, in a preferred manner).

In continuing to refer to FIG. 3, the emergency signal-transmitting device 110 is shown comprising the device-housing 112. A face of the device-housing 112 may comprise a built-in display having at least one light 170. The at least one light 170 may be programmed to illuminate when the signal-transmitter 116 is actively transmitting the emergency signal 135 to the signal-receiver 124 of the emergency signal receiving unit 120 useful for signaling to the user 40 a successful transmission of the emergency signal 135. In other embodiments, at least one light 170 may further be useful to indicate a level of power available of the power source 118. This may particularly be useful to indicate to the user 40 that batteries may need to be changed in embodiments of the present invention where the power source 118 comprises at least one battery. Other power sources 118 may include a USB connector, a 12-volt cigarette lighter socket connector, or even a built-in version to the emergency vehicle 5 such that the power source 118 comprises a vehicle battery of the emergency vehicle 5.

In other embodiments, the face of the device-housing 112 may comprise a power button in addition to the signal-activator 115. The power button may be useful for turning off and on the emergency signal transmitting device 110. During an off condition, power may be saved.

As may be appreciated, the signal-transmitter 116 may comprise a radio frequency (RF) transmitter, a wireless modem, a Bluetooth transmitter, and the like as known in the art. Preferably, the signal-transmitter 116 is configured to transmit the emergency signal 135 across a range of approximately 300 meters. It should be appreciated however that other embodiments may comprise the signal-transmitter 116 capable of transmitting the emergency signal 135 across a greater range than 300 meters.

In continuing to refer to FIG. 3, the emergency signal receiving unit 120 may comprise the receiving-processor 122 in communication with the signal-receiver 124 and at least one emergency signal indicator 126 (such as the display screen 130). The display screen 130 may be in communication with the receiving-processor 122 and the signal-receiver 124. The emergency signal receiving unit 120 may further comprise the emergency signal receiving power source 128 for providing operating power to the emergency signal receiving unit 120. Furthermore, the emergency signal receiving unit 120 may comprise a power button 190 for turning on and off the emergency signal receiving unit 120.

The emergency signal receiving power source 128 may comprise at least one battery that is rechargeable or non-rechargeable, a USB connector, a 12-volt cigarette lighter socket connector, or even a built-in version to the civilian vehicle 10 such that the emergency signal receiving power source 128 comprises an automobile battery of the civilian vehicle 10. It should therefore be noted that at least one emergency signal receiving power source 128 of the emergency signal receiving unit 120 comprises a vehicle power supply of the civilian vehicle 10.

In continuing to refer to FIG. 3, the emergency signal receiving unit 120 may further comprise an audio module 180 including at least one speaker 182. In such a manner, the at least one emergency signal indicator 126 of the emergency signal receiving unit 120 may comprise an audible alert 184 configured to communicate the beacon 160 to the motorist 45. In one embodiment, the audible alert 184 may comprise a high pitch sound programmed to be heard by the motorist 45 over music emitting from a vehicle radio, as well as other noises. The high pitch sound may comprise a beeping sound, or a steady non-beeping sound.

In other embodiments, the audible alert 184 may comprise a recorded warning message to the motorist 45 that at least one emergency vehicle 5 is oncoming. The recorded warning message may further include a direction the emergency vehicle 5 is coming from as also indicated by the plurality of directional arrows 132 on the display screen 130 of the emergency signal receiving unit 120. It should be noted that in some embodiments of the present invention, the motorist 45 is able to turn off the audible alert 184 by pressing a button on the display screen 130. In other embodiments, the display screen 130 may comprise a touch screen featuring a variety of command prompts for controlling the audible alert 184, as well as other emergency signal indicators 126, of the emergency signal receiving unit 120.

Yet in other embodiments, the emergency signal receiving unit 120 may comprise at least one warning-light 186 configured to illuminate when the at least one emergency vehicle 5 enters the zone of proximity 160 to the at least one civilian vehicle 10. Further, the at least one warning-light 186 may preferably comprise a purple light emitting diode 188 configured to illuminate a purple colored light when the at least one emergency vehicle 5 enters the zone of proximity 160 to the at least one civilian vehicle 10. The purple colored light may be preferred because it is a different color than typical colors that illuminate inside most civilian vehicles 10 (such as red, green, white, yellow, etc.). Further, it is contemplated that the purple colored light is more non-obtrusive than other colors, yet will still get the attention of the motorist 45.

In still referring to FIG. 3, it should be noted that the display screen 130 of the emergency signal receiving unit 120 may be programmed to show a plurality of directional arrows 132 for indicating a direction of at least one emergency vehicle 5 that may be oncoming. Furthermore, the display screen 130 may be programmed to display an approximate distance between the at least one civilian vehicle 10 and the at least one emergency vehicle 5. The distance may be displayed digitally on the display screen 130. As the distance becomes closer, the audible alert 184 may beep faster or the audible alert 184 may become louder.

In continuing to refer to the emergency signal receiving unit 120, it should be noted that the emergency signal receiving unit 120 may generally comprise three operating conditions: active mode, standby mode, and powered off mode.

Active mode occurs when the at least one emergency signal 135 is actively being transmitted by the signal-transmitter of the 116 and received by the signal-receiver 124 of the emergency signal receiving unit 120. During active mode, the receiving-processor 122 is activating emergency signal indicator(s) 126 of the emergency signal receiving unit 120 (such as the display screen 130, the plurality of directional arrows 132, and the warning-light 186).

Standby mode occurs when the emergency signal receiving unit 120 is powered on however there are no emergency vehicles 5 transmitting at least one emergency signal 135 within the zone of proximity 160 to the at least one civilian vehicle 10. During standby mode, no lights or sounds are emitted by the emergency signal receiving unit 120. In some embodiments, the display screen 130 may simply display a current time as kept by an internal clock. In other embodiments, the display screen 130 may continuously display a distance between the civilian vehicle 10 and the closest emergency vehicle 5 that is outside a range of approximately 300 meters.

Powered off mode occurs when the motorist 45 turns off the emergency signal receiving unit 120. In some embodiments, the motorist 45 may be prevented from powering off the emergency signal receiving unit 120 when the civilian vehicle 10 is in motion.

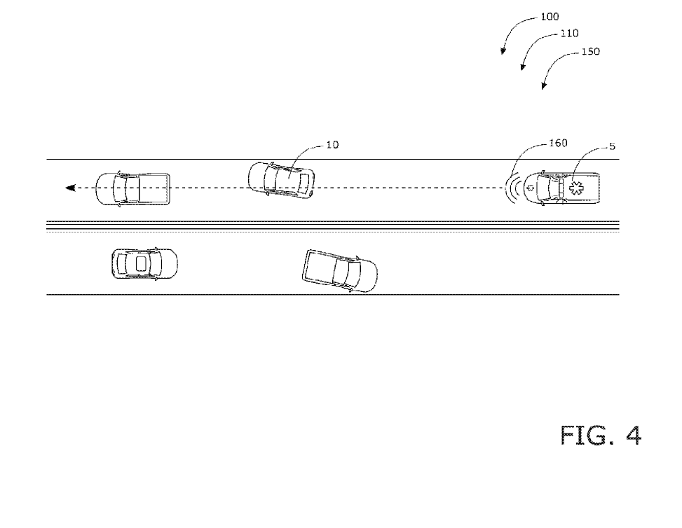

Referring now to FIG. 4 showing a birds-eye view of the non-obtrusive oncoming emergency vehicle prewarning system 100 of FIGS. 1-3 showing an emergency signal 135 transmitted from the emergency signal-transmitting device 110 to the emergency signal receiving unit(s) 120 within range thereby indicating to motorists 45 of civilian vehicles 10 that the emergency vehicle 5 is oncoming and to move aside according to an embodiment of the present disclosure. As previously discussed, the zone of proximity 160 may comprise a range of approximately 300 meters (or the equivalent of 2 blocks). In other embodiments, the zone of proximity 160 may comprise a greater range than 300 meters (i.e., up to 1000 meters).

In a preferred embodiment of the present disclosure, the non-obtrusive oncoming emergency vehicle prewarning system 100 may comprise the emergency signal transmitting device 110 configured to be installable to the at least one emergency vehicle 5, the emergency signal alert device 110 comprising the device-housing 112 configured to mount to a dashboard of the at least one emergency vehicle 5 via the dashboard mount 174 (such as an adhesive), the device-housing 112 internally including the signal-transmitting-processor 114, the signal-transmitter 114 configured to transmit over a range of approximately 300 meters, and at least one power source 118 configured to provide operating power to the emergency signal alert device 110.

The non-obtrusive oncoming emergency vehicle prewarning system 100 may further comprise the emergency signal receiving unit 120 configured to be installable inside at least one civilian vehicle 10; the emergency signal receiving unit including the receiving-processor 122 in communication with the signal-receiver 124 and at least one emergency signal indicator 126, the display screen 130 in communication with the receiving-processor 122 and the signal-receiver 124, the audio module 180 having at least one speaker 182, the audio module 180 programmed to emit a high pitched audible alert 184 when the signal-receiver 124 receives at least one emergency signal 135 transmitted by the signal-transmitter 116, at least one warning-light 186 configured to illuminate a purple color when the signal-receiver 124 receives at least one emergency signal 135, and an emergency signal receiving power source 128 for providing operating power to the emergency signal receiving unit 120.

The signal-transmitter 116 of the emergency signal transmitting device 110 is configured to wirelessly transmit the at least one emergency signal 135 to the signal-receiver 124 of the emergency signal receiving unit 120 when activated by the user 40 via the signal-activator 115. The at least one emergency signal indicator 126 essentially serves as the beacon 160, the beacon 160 configured to alert the motorist 45 of the at least one civilian vehicle 10 that the at least one emergency vehicle 5 is in the zone of proximity 160 to the at least one civilian vehicle 10. During use, the display screen 130 is programmed to display the plurality of directional arrows 132 configured to indicate a relative direction of the at least one emergency vehicle 5 such that the motorist 45 has sufficient reaction time to allow the at least one emergency vehicle 5 to safely pass to prevent an accident from occurring.

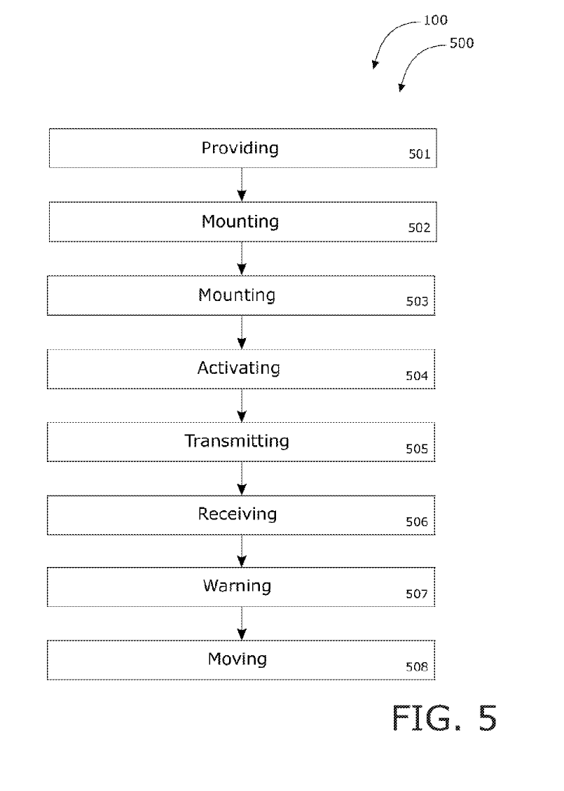

FIG. 5 is a flow diagram 550 illustrating a method of use 500 for using a non-obtrusive emergency vehicle prewarning system 100, according to an embodiment of the present disclosure. As illustrated, the method 500 of use may include the steps of: step one 501, providing an emergency signal transmitting device 110 for use by at least one emergency vehicle 5 and an emergency signal receiving unit 120 for use by at least one civilian vehicle 10; step two 502, mounting the emergency signal transmitting device 110 inside the at least one emergency vehicle 5 via a dashboard mount 174; step three 503, mounting the emergency signal receiving unit 120 inside the at least one civilian vehicle 10; step four 504, activating the emergency signal transmitting device 110 when the at least one emergency vehicle 5 is in motion and on an emergency call; step five 505, transmitting at least one emergency signal 135 via a signal-transmitter 116 of the emergency signal transmitting device 110; step six 506, receiving the at least one emergency signal 135 via a signal-receiver 124 of the emergency signal receiving unit 120; step seven 507, warning a motorist 45 of the at least one civilian vehicle 10 of a proximity of the at least one emergency vehicle 5; and step eight 508, moving the at least one civilian vehicle 10 to a side of a road enabling the at least one emergency vehicle 5 to safely pass.

The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the non-obtrusive emergency vehicle prewarning system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A non-obtrusive oncoming emergency vehicle prewarning system, the system comprising:
an emergency signal transmitting device configured to be installable to an at least one emergency vehicle, the emergency signal alert device comprising a device-housing, the device-housing internally including a signal-transmitting-processor, a signal-transmitter, and at least one power source configured to provide operating power to the emergency signal alert device;
wherein the signal-transmitting-processor is in communication with the signal-transmitter and a signal-activator, the emergency signal transmitting power source; the signal-activator located on a face of the device-housing, and
an emergency signal receiving unit configured to be installable to at least one civilian vehicle; the emergency signal receiving unit comprising a receiving-processor in communication with a signal-receiver and at least one emergency signal indicator, the emergency signal receiving unit further comprising a display screen, the display screen in communication with the receiving-processor and the signal-receiver, and an emergency signal receiving power source for providing operating power to the emergency signal receiving unit;
wherein the signal-transmitter of the emergency signal transmitting device is configured to wirelessly transmit at least one emergency signal to the signal-receiver of the emergency signal receiving unit when activated by a user via the signal-activator;
wherein the emergency signal transmitting device is configured with an active mode, a standby mode, and a powered off mode;
wherein the emergency signal transmitting device and the emergency signal receiving unit are structured and arranges such that the standby mode of occurs when the emergency signal transmitting device and the emergency signal receiving unit are powered but no emergency vehicle is transmitting the at least one emergency signal within the zone of proximity to the at least one civilian vehicle;
wherein the at least one emergency signal indicator comprises a beacon, the beacon configured to alert a motorist of the at least one civilian vehicle that the at least one emergency vehicle is in a zone of proximity to the at least one civilian vehicle; and
wherein the display screen is programmed to display a plurality of directional arrows, the plurality of directional arrows configured to indicate a direction of the at least one emergency vehicle such that the motorist has sufficient reaction time to allow the at least one emergency vehicle to safely pass and to prevent an accident.

2. The non-obtrusive oncoming emergency vehicle prewarning system of claim 1, wherein the face of the device-housing of the emergency signal transmitting device comprises at least one light.

3. The non-obtrusive oncoming emergency vehicle prewarning system of claim 2, wherein the at least one light is activated when the signal-transmitter is transmitting the emergency signal to the signal-receiver of the emergency signal receiving unit useful for signaling to the user a successful transmission.

4. The non-obtrusive oncoming emergency vehicle prewarning system of claim 3, wherein the signal-activator of the emergency signal transmitting device comprises a power button.

5. The non-obtrusive oncoming emergency vehicle prewarning system of claim 4, wherein the device-housing of the emergency signal transmitting device is mountable to a dashboard of the at least one emergency vehicle via a dashboard mount.

6. The non-obtrusive oncoming emergency vehicle prewarning system of claim 5, wherein the emergency signal receiving unit comprises an audio module having at least one speaker.

7. The non-obtrusive oncoming emergency vehicle prewarning system of claim 6, wherein the at least one emergency signal indicator of the emergency signal receiving unit comprises an audible alert configured to communicate the beacon to the motorist.

8. The non-obtrusive oncoming emergency vehicle prewarning system of claim 7, wherein the audible alert comprises a high pitch sound programmed to be heard by the motorist over music emitting from a vehicle radio.

9. The non-obtrusive oncoming emergency vehicle prewarning system of claim 1, wherein the signal-transmitter comprises a radio frequency transmitter programmed to transmit the at least one emergency signal.

10. The non-obtrusive oncoming emergency vehicle prewarning system of claim 9, wherein the radio frequency transmitter is configured to transmit over a range of approximately 300 meters.

11. The non-obtrusive oncoming emergency vehicle prewarning system of claim 1, wherein the emergency signal receiving unit is compactly structured to be inconspicuously mounted to a dashboard of the at least one civilian vehicle such as to not distract the motorist while driving.

12. The non-obtrusive oncoming emergency vehicle prewarning system of claim 11, wherein the display screen is programmed to display a distance between the at least one civilian vehicle and the at least one emergency vehicle.

13. The non-obtrusive oncoming emergency vehicle prewarning system of claim 12, wherein the emergency signal receiving unit comprises at least one warning-light configured to illuminate when the at least one emergency vehicle enters the zone of proximity to the at least one civilian vehicle.

14. The non-obtrusive oncoming emergency vehicle prewarning system of claim 13, wherein the at least one warning-light comprises a purple light emitting diode configured to illuminate a purple colored light when the at least one emergency vehicle enters the zone of proximity to the at least one civilian vehicle.

15. The non-obtrusive oncoming emergency vehicle prewarning system of claim 14, wherein the emergency signal receiving unit comprises a power button.

16. The non-obtrusive oncoming emergency vehicle prewarning system of claim 15, wherein the at least one power source of the emergency signal receiving unit comprises at least one battery.

17. The non-obtrusive oncoming emergency vehicle prewarning system of claim 15, wherein the at least one power source of the emergency signal receiving unit comprises a vehicle power supply.

18. A non-obtrusive oncoming emergency vehicle prewarning system, the system comprising:
an emergency signal transmitting device configured to be installable to an at least one emergency vehicle, the emergency signal alert device comprising a device-housing configured to mount to a dashboard of the at least one emergency vehicle via a dashboard mount, the device-housing internally including a signal-transmitting-processor, a signal-transmitter configured to transmit over a range of approximately 200 meters, and at least one power source configured to provide operating power to the emergency signal alert device;
wherein the signal-transmitting-processor is in communication with the signal-transmitter and a signal-activator, the emergency signal transmitting power source; the signal-activator located on a face of the device-housing, the face further comprising at least one light, the at least one light activates when the signal-transmitter transmits; and
an emergency signal receiving unit configured to be installable to at least one civilian vehicle; the emergency signal receiving unit comprising a receiving-processor in communication with a signal-receiver and at least one emergency signal indicator, the emergency signal receiving unit further comprising a display screen, the display screen in communication with the receiving-processor and the signal-receiver, the emergency signal receiving unit further comprising an audio module having at least one speaker, the audio module programmed to emit a high pitched audible alert when the signal-receiver receives at least one emergency signal transmitted by the signal-transmitter, the emergency signal receiving unit further comprising at least one warning-light configured to illuminate when the signal-receiver receives at least one emergency signal transmitted by the signal-transmitter, and an emergency signal receiving power source for providing operating power to the emergency signal receiving unit;
wherein the signal-transmitter of the emergency signal transmitting device is configured to wirelessly transmit the at least one emergency signal to the signal-receiver of the emergency signal receiving unit when activated by a user via the signal-activator;
wherein the emergency signal transmitting device is configured with an active mode, a standby mode, and a powered off mode;
wherein the emergency signal transmitting device and the emergency signal receiving unit are structured and arranges such that the standby mode of occurs when the emergency signal transmitting device and the emergency signal receiving unit are powered but no emergency vehicle is transmitting the at least one emergency signal within the zone of proximity to the at least one civilian vehicle;
wherein the at least one emergency signal indicator comprises a beacon, the beacon configured to alert a motorist of the at least one civilian vehicle that the at least one emergency vehicle is in a zone of proximity to the at least one civilian vehicle; and
wherein the display screen is programmed to display a plurality of directional arrows, the plurality of directional arrows configured to indicate a direction of the at least one emergency vehicle such that the motorist has sufficient reaction time to allow the at least one emergency vehicle to safely pass and to prevent an accident.

19. The non-obtrusive oncoming emergency vehicle prewarning system of claim 18, further comprising set of instructions; and
wherein the oncoming emergency vehicle prewarning system is arranged as a kit.

20. A method of using the non-obtrusive oncoming emergency vehicle prewarning system of claim 18, the method comprising the steps of:
providing an emergency signal transmitting device for use by at least one emergency vehicle and an emergency signal receiving unit for use by at least one civilian vehicle;
mounting the emergency signal transmitting device inside the at least one emergency vehicle;
mounting the emergency signal receiving unit inside the at least one civilian vehicle;
activating the emergency signal transmitting device when the at least one emergency vehicle is in motion transmitting at least one emergency signal via a signal-transmitter of the emergency signal transmitting device;
receiving the at least one emergency signal via a signal-receiver of the emergency signal receiving unit;
warning a motorist of the at least one civilian vehicle of a proximity of the at least one emergency vehicle;
moving the at least one civilian vehicle to a side of a road enabling the at least one emergency vehicle to safely pass; and
returning the emergency signal receiving unit to a standby mode after the at least one emergency vehicle has passed, or has changed direction.
